(19) United States
(12) Patent Application Publication
(10) Pub. No.: US 2010/0017394 A1
(43) Pub. Date: Jan. 21, 2010

(54) WEB PAGE PROVIDING APPARATUS AND METHOD FOR INTERLOCKING WEB PAGE WITH RANKING

(75) Inventor: Takeshi TERADA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/467,190

(22) Filed: May 15, 2009

(30) Foreign Application Priority Data
Jul. 17, 2008 (JP) 2008-186430

(51) Int. Cl. G06F 17/30

(52) U.S. Cl. 707/5; 707/E17.108; 707/E17.044; 707/100

(57) ABSTRACT

A Web page providing apparatus provides a Web page on a Network. The Web page providing apparatus includes a search word collection part that accesses a Web site on a network and collects search words from the Web site, an acquisition part that acquires ranking information of the search words from the Web site, a search word ranking part that refers to the ranking information and ranks the search words, a ranking search word accumulation part that stores the search words ranked by the search word ranking part and a Web page modification part that describes the search words into a providing Web page according to ranking of the ranked search words to modify the Web page.

### CROSS-REFERENCE TO RELATED APPLICATIONS

This application is based upon and claims the benefit of priority of the prior Japanese Patent Application No. 2008-186430, filed on Jul. 17, 2008, the entire contents of which are incorporated herein by reference.

### FIELD

The embodiments discussed herein are related to providing a Web page on the Internet and modification thereof. A certain aspect of the embodiments discussed herein is related to a Web page providing apparatus in which keywords such as buzzwords are automatically reflected in a Web page published on the Internet, a method for interlocking a Web page with ranking and a program thereof.

### BACKGROUND

Conventionally, in order to increase the number of accesses to a Web page published on a network, it is an important element that there is a word easy to be searched in a Web page. In a portal site, etc. executing search of a Web site, when search is executed by a buzzword, increase of the number of accesses is expected by existence of the buzzword.

Concerning a system executing search of a Web page with using buzzwords as keywords, Japanese Laid-open Patent Publication No. 2006-293920 discloses that vote points of each sponsor for each of buzzword candidates selected in advance are managed, and buzzwords are decided based on the vote points. A buzzword to be displayed based on a preset criterion from the decided buzzwords is selected. A hypertext content that includes a buzzword list or sentence including the selected buzzword is generated, and the generated hypertext content is transferred to a user terminal. When the buzzword list or the buzzword in the sentence including the buzzword, transferred from a portal terminal, is clicked by a user, a search result of contents on a website is transferred to a source of a search request (Abstract and FIG. 2, etc.).

Concerning a function of collecting information relating to a new word, Japanese Laid-open Patent Publication No. 2004-157897 discloses that words and information on the dates when the words appeared are stored in a dictionary, the words are extracted from a document, the dictionary refers the extracted words, whether the words are new is determined as a referring result, e.g., search is performed by the Internet by using the determined new words as keys, and results are obtained to be displayed (Abstract and FIG. 1, etc.).

In order to increase the number of accesses to a Web page in response to search by buzzwords, it is necessary that the buzzwords are searched from other Web pages, etc., and the buzzword is described into the Web page. Since buzzwords on a network continuously vary, it is necessary to always monitor buzzwords. Modifying a Web page like describing buzzwords correspondingly to variation thereof is troublesome operation, and if the operation is neglected, reduction of the number of accesses cannot be avoided.

Concerning such request and problems, there is no disclosure or suggestion thereof in Japanese Laid-open Patent Publication Nos. 2006-293920 and 2004-157897, and no disclosure or suggestion about structure, etc. solving them is presented.

### SUMMARY

According to an aspect of an embodiment of the invention, a Web page providing apparatus providing a Web page on a network includes a search word collection part that accesses a Web site on a network and collects a search word from the Web site, an acquisition part that acquires ranking information of the search word from the Web site, a search word ranking part that refers to the ranking information and ranks the search word, a ranking search word accumulation part that stores the search word ranked by the search word ranking part and a Web page modification part that describes the search word into a providing Web page according to ranking of the ranked search word to modify the Web page.

According to such configuration, since a Web site on a network is accessed and search words are collected, ranking information of the search words is acquired from the Web site, the ranking information is referred and the search words are ranked to be accumulated, and according to ranking of the search words, the search words are described into a providing Web page to modify the Web page, if search words are keywords such as buzzwords, in search in a portal site, etc. that executes search of a Web site, a search ranking of a Web page can become high.

According to an aspect of an embodiment of the invention, a method for making a Web page provided on a network interlock with ranking includes accessing a Web site on a network and collecting a search word from the Web site, acquiring ranking information of the search word from the Web site, referring to the ranking information and ranking the search word, storing the ranked search word along with the ranking information into a ranking search word accumulation part and describing the search word into a providing Web page according to ranking of the ranked search word to modify the Web page.

According to an aspect of an embodiment of the invention, there is provided a computer readable recording medium storing a program for making a Web page provided on a network interlock with ranking, the program allowing a computer to execute accessing a Web site on a network and collecting a search word from the Web site, acquiring ranking information of the search word from the Web site, referring to the ranking information and ranking the search word, storing the ranked search word along with the ranking information into a ranking search word accumulation part, and describing the search word into a providing Web page according to ranking of the ranked search word to modify the Web page.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features and advantages of the embodiments of the present invention are more clearly understood by referring to the attached drawings and each of the embodiments.

### BRIEF DESCRIPTION OF DRAWINGS

FIG. 1 depicts a Web page providing system according to a first embodiment;

FIG. 2 depicts a data configuration of a search word database;

FIG. 3 depicts a data configuration of a search word master database;

FIG. 4 depicts a data configuration of a point table of search words;

FIG. 5 depicts a data configuration of a search word total ranking database;

FIGS. 6A-6C depict parts of a WWW (World Wide Web) document;

FIG. 7 is a flowchart depicting processing procedure of making a WWW document;

FIG. 8 depicts a WWW document;

FIG. 9 is a flowchart depicting processing procedure of collecting search words;

FIG. 10 is a flowchart depicting processing procedure of analyzing search words;

FIG. 11 is a flowchart depicting a display process of search words on a WWW document;

FIG. 12 is a flowchart depicting processing procedure of collecting and analyzing search words and making a WWW document according to a second embodiment;

FIG. 13 depicts a data configuration of a search word database according to a third embodiment;

FIG. 14 depicts a data configuration of a search word master database;

FIG. 15 depicts a data configuration of a search word database when data is analyzed;

FIG. 16 depicts a data configuration of a search word total ranking database;

FIG. 17 depicts a data configuration of a search word database when data is analyzed;

FIG. 18 depicts a data configuration of a search word database when data is analyzed;

FIG. 19 depicts a score table of search words;

FIG. 20 depicts a score table of search words;

FIG. 21 depicts a ranking transition table of search words;

FIG. 22 depicts transition of rankings of search words;

FIG. 23 depicts a data configuration of a search word total ranking database;

FIG. 24 is a flowchart depicting processing procedure of collecting and analyzing search words and making a WWW document;

FIG. 25 depicts a WWW document at a time point on January, 1;

FIG. 26 depicts a WWW document at a time point on January, 2;

FIG. 27 depicts a WWW document at a time point on January, 3; and

FIG. 28 depicts a computer configuring a server according to a fourth embodiment.

### DESCRIPTION OF EMBODIMENTS

Embodiments of the present invention provide a Web page on a network such as the Internet, acquires keywords such as buzzwords (search words) and ranking information from other Web sites, and ranks the keywords with referring to this ranking information to accumulate the keywords. According to the rankings, the ranked keywords are reflected in the providing Web page. According to such configuration, since a Web page is automatically modified and updated in response to transition of keywords such as buzzwords, when searched by a browser such as a search engine, the Web page can be displayed on a high ranking of a search result thereof and raising a ranking of the Web page is facilitated.

### First Embodiment

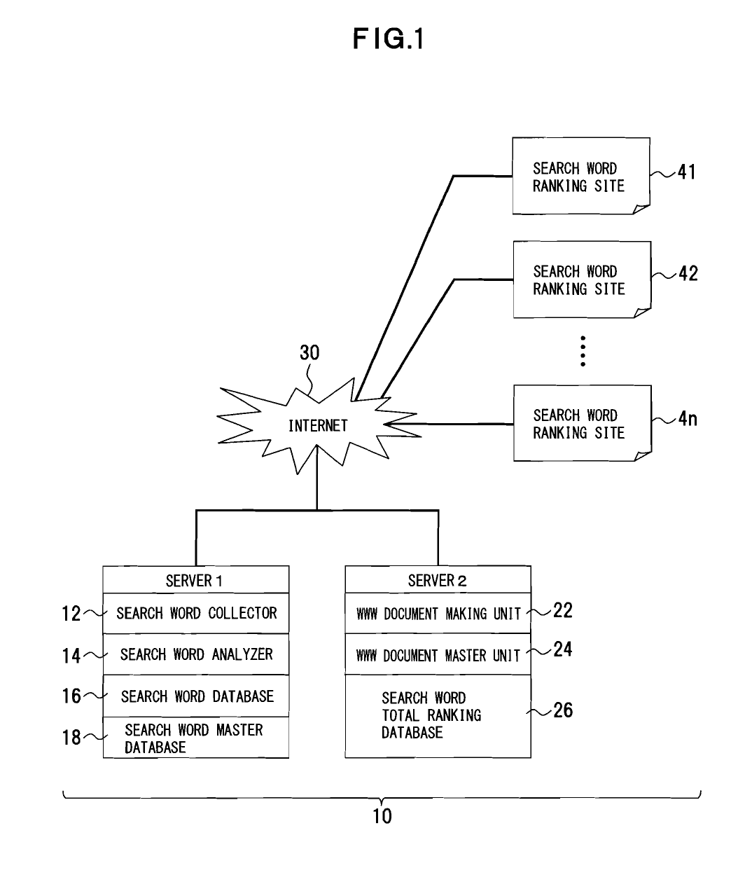

A first embodiment will now be described with reference to FIG. 1. FIG. 1 depicts a Web page providing system. The configuration depicted in FIG. 1 is one example, and such configuration does not limit the present invention.

This Web page providing system 10 is a system that keywords such as buzzwords as search words and ranking information are acquired from the Internet, a Web page is modified by automatically reflecting the keywords and keywords ranked with reference to the ranking information, and the Web page is published on the Internet. This Web page providing system 10 includes a server 1, a server 2, an Internet 30 and search word ranking sites 41, 42 . . . 4n.

The server 1 is a computer that is one example of a WEB page providing apparatus. The server 1 includes a search word collector 12, a search word analyzer 14, a search word database (DB) 16 and a search word master database (DB) 18.

The search word collector 12 is a search word collection means (part) collecting search words from Web sites, and an acquisition means (part) acquiring ranking information of search words. The search word collector 12 acquires sources of Web pages (information sources) from a part or all of the search word ranking sites 41, 42 . . . 4n. Then, search words and rankings are extracted from the sources. For example, a word in ranking, XXX is described as <a href=“http://yyyzzz.com”>XXX</a> in a source, a sandwiched part between “>” and “<” in this line is extracted, and XXX is acquired as a search word in ranking. Similarly, rankings of search words are acquired. In case of a site ranked by a field, if a field of the site corresponds with a field of a ranking site, search words are collected from ranking by a field. Such search operation is performed periodically, and then data of search words is collected. In case of a site without ranking even though there is a list of search words, only search words are acquired.

The search word analyzer 14 totally ranks search words based on information in the search word database 16. By weighting tallied search words with referred sites, acquired dates and times and rankings for a certain period, each search word is totally ranked. If filtering of search words is necessary, the preset search word master database 18 is referred, and an exclusion flag is tagged to words (terms) not in this search word master database 18. An exclusion flag for a specific search word can be also tagged by manual. As the above, total ranking of search words for a certain period is made, and is stored in a search word total ranking database 26.

The search word database 16 is an accumulation means (part) holding search word information collected by the search word collector 12, a ranking search word accumulation means (part) storing ranked search words and a recording means (part) recording various kinds of data. In this search word database 16, collected search word information and ranking information such as rankings, referred sites and acquired dates and times are stored.

The search word master database 18 is a storing means (part) storing words necessary for filtering of search words. In the search word master database 18, words necessary for filtering are preset.

The server 2 is one example of a WEB page providing apparatus, and includes a WWW (World Wide Web) document making unit 22, a WWW document master unit 24 and the search word total ranking database (DB) 26.

The WWW document making unit 22 is a WWW document making means (part) and an Web page modification means (part). The WWW document making unit 22 implants data of the search word total ranking database 26 into a preset position of the WWW document master unit 24 (such as a keyword tag). For example, if a buzzword is implanted into a keyword tag, a configuration of a WEB page is divided into the following three parts:
a part above the keyword tag;
the keyword tag;
<meta name=“keywords” content=“buzzword 1, buzzword 2, . . . />; and

iii) a part below the keyword tag.

The WWW document making unit 22 describes i), ii) and iii) in order when making a WWW document. While the parts of i) and iii) are fixed areas, the part of ii) refers to the search words total ranking database 26 and displays current buzzwords. Thereby, a WWW document where buzzwords are implanted into a keyword tag, etc. is made. In this case, buzzword 1, buzzword 2 . . . are one example of search words, and are keywords for highly ranking a search result of a Web page.

The above example is a case that a part of a collected keywords is implanted only into the part of ii). It can be performed that popular keywords are implanted into a part except the part of ii). In this case, there exist a fixed area and a dynamically changing area in a part where the keywords are implanted.

The WWW document master unit 24 stores an original text of a WWW document. An original text thereof includes a keyword tag, etc. In the search word total ranking database 26, search word total ranking is stored.

The search word ranking sites 41, 42 . . . 4n are various sites providing search words and rankings thereof, etc. on the Internet 30.

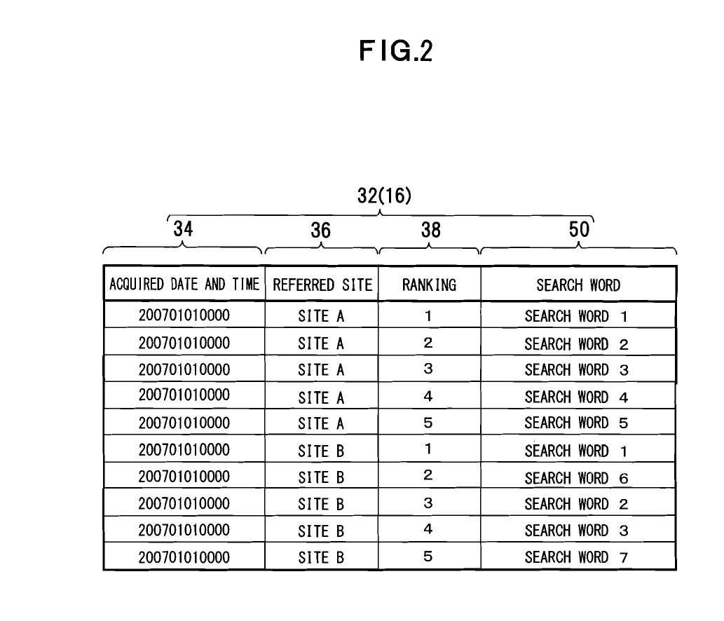

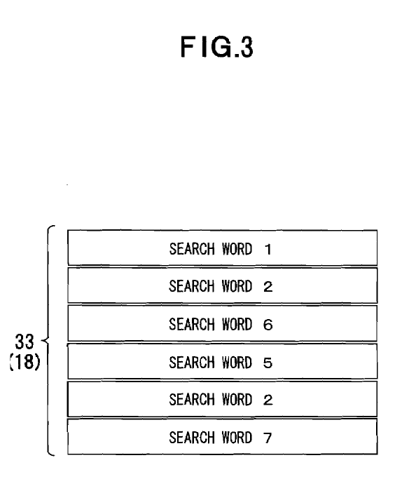

The search word database 16 and the search word master database 18 will be described with reference to FIGS. 2 and 3. FIG. 2 depicts a data configuration of a search word database and FIG. 3 depicts a data configuration of a search word master database. FIGS. 2 and 3 are one example, and such configurations do not limit the present invention.

For this search word database 16, a search word table 32 is set as a data table where information such as search words acquired by collection, acquired dates and times thereof, referred sites and rankings are stored. In this search word table 32, as depicted in FIG. 2, an acquired date and time field 34, a referred site field 36, a ranking field 38 and a search word field 50 are set. In the acquired date and time field 34, acquired date and time information of search words is stored. In the referred site field 36, acquired site names (site A, site B . . . ) are stored. In the ranking field 38, numbers representing rankings in the referred sites of search words acquired from referred sites (1, 2 . . . ) are stored. In the search word field 50, search words representing search objects (search word 1, search word 7, search word 3 . . . ) are stored.

Therefore, if, for example, “search word 7” in the search word database 16 is referred, it is seen that acquired date and time thereof is “200701010000”, a referred site is “site B” and a ranking thereof is “5”.

For the search word master database 18, a search word master table 33 is set as a data table of a search word master. In this search word master table 33, as depicted in FIG. 3, for example, search word 1, search word 2 . . . are stored as specified search words.

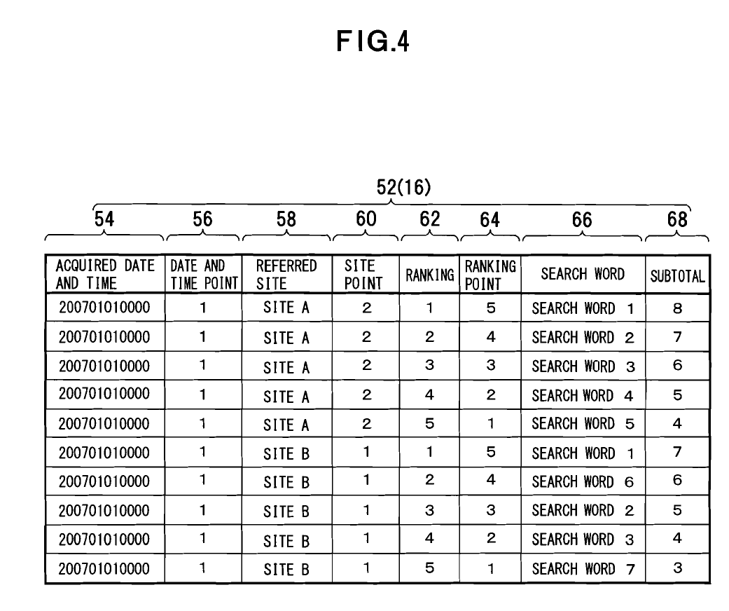

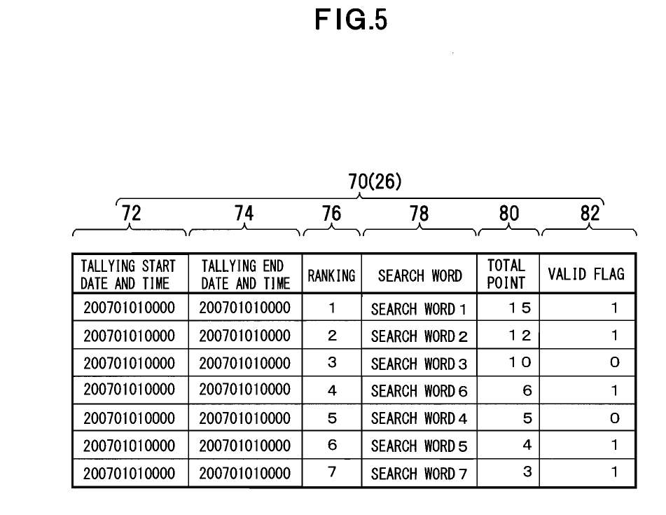

A point giving process of search words and the search word total ranking database 26 will be described with reference to FIGS. 4 and 5. FIG. 4 depicts a data configuration of a point table of search words and FIG. 5 depicts a data configuration of a search word total ranking database. FIGS. 4 and 5 are one example, and such configurations do not limit the present invention.

A point giving process of search words is executed by the search word analyzer 14. Concerning search words in the above described search word database 16, acquired dates and times, referred sites and rankings are used as ranking information, and are evaluated, and a point for ranking a search words is given. This point giving is a pre-process of ranking.

In this embodiment, “a date and time point” is evaluated for acquired date and time, and all “date and time points” in the search word database 16 are set as a point “1”. As to referred sites, “site A” is set as a site point “2” and “site B” is set as a site point “1”. As to a ranking in each site, “ranking 1” is set as a ranking point “5”, “ranking 2” is set as a ranking point “4”, “ranking 3” is set as a ranking point “3” . . . . These points are summed, and points are given to each search word. For example, a point of “search word 1” acquired on date and time “200701010000” and from “site A”, N1 becomes

N1=date and time point+site point+ranking point=1+2+5=8 (1)

wherein, the best point “8” is given. A search word table 52 (FIG. 4) is set in the search word database 16 as a data table storing this point giving processed-search words. For this search word table 52, as depicted in FIG. 4, an acquired date and time field 54, a date and time point field 56, a referred site field 58, a site point field 60, a ranking field 62, a ranking point field 64, a search word field 66 and a subtotal field 68 are set. The acquired date and time field 54 corresponds to the acquired date and time field 34 (FIG. 2), the referred site field 58 corresponds to the referred site field 36 (FIG. 2), the ranking field 62 corresponds to the ranking field 38 (FIG. 2) and the search word field 66 corresponds to the search word field 50 (FIG. 2), and they are stored in the search word database 16 as well.

To such point giving processed-search words, total rankings are given and this point giving processed-search words are stored to the search word total ranking database 26 (FIG. 1). For this search word total ranking database 26, a search word total ranking table 70 (FIG. 5) is set as a data table storing ranking data. For this search word total ranking table 70, as depicted in FIG. 5, a tallying start date and time field 72, a tallying end date and time field 74, a ranking field 76, a search word field 78, a total point field 80 and a valid flag field 82 are set. The tallying start date and time field 72 stores date and time information on start of tallying, the tallying end date and time field 74 stores date and time information on end of tallying, the ranking field 76 stores numeric values representing ranking information, the search word field 78 stores search words and the total point field 80 stores total points. In the valid flag field 82, a valid flag “1” or an exclusion flag “0” is tagged.

In this case, total points of “search word 1”, “search word 2” . . . are total values of a subtotal point of each site, wherein:

a total point of “search word 1”=a subtotal point of site A+a subtotal point of site B . . .

a total point of “search word 2”=a subtotal point of site A+a subtotal point of site B . . .

a total point of “search word 3”=a subtotal point of site A+a subtotal point of site B . . .

. . .

a total point of “search word n”=a subtotal point of site A+a subtotal point of site B (2)

Therefore, as is apparent from the search word table 52 (FIG. 4) and the search word total ranking table 70 (FIG. 5), “search word 1” obtains a subtotal “8” in “site A” and a subtotal “7” in “site B”. If these points are summed, “search word 1” obtains a total point “15”, and is ranked first. Like the above, “search word 2” obtains a subtotal “7” in “site A” and a subtotal “5” in “site B”. If these points are summed, “search word 2” obtains a total point “12”, and is ranked second. “Search word 3” obtains a subtotal “6” in “site A” and a subtotal “4” in “site B”. If these points are summed, “search word 3” obtains a total point “10”, and is ranked third. “Search word 4” obtains a subtotal “5” in “site A” and a subtotal “0” in “site B”. If these points are summed, “search word 4” obtains a total point “5” and is ranked fifthly. “Search word 5” obtains a subtotal “4” in “site A” and a subtotal “0” in “site B”. If these points are summed, “search word 5” obtains a total point “4” and is ranked sixthly. “Search word 6” obtains a subtotal “0” in “site A” and a subtotal “6” in “site B”. If these points are summed, “search word 6” obtains a total point “6”, and is ranked fourthly. “Search word 7” obtains a subtotal “0” in “site A” and a subtotal “3” in “site B”. If these points are summed, “search word 7” obtains a total point “3”, and is ranked seventhly.

The search word master table 33 (FIG. 3) is referred as to these “search word 1”, “search word 2” . . . . Since for the search word master table 33, “search word 1”, “search word 2”, “search word 6”, “search word 5”, “search word 2” and “search word 7” are set but “search word 3”, “search word 4” . . . are not set, the valid flag “1” is tagged to the former, and the exclusion flag “0” is tagged to the latter.

Like the above, implantation of search words having high rankings into a Web page brings the Web page including the search words being displayed on a high rankings of a search result that targets the search words.

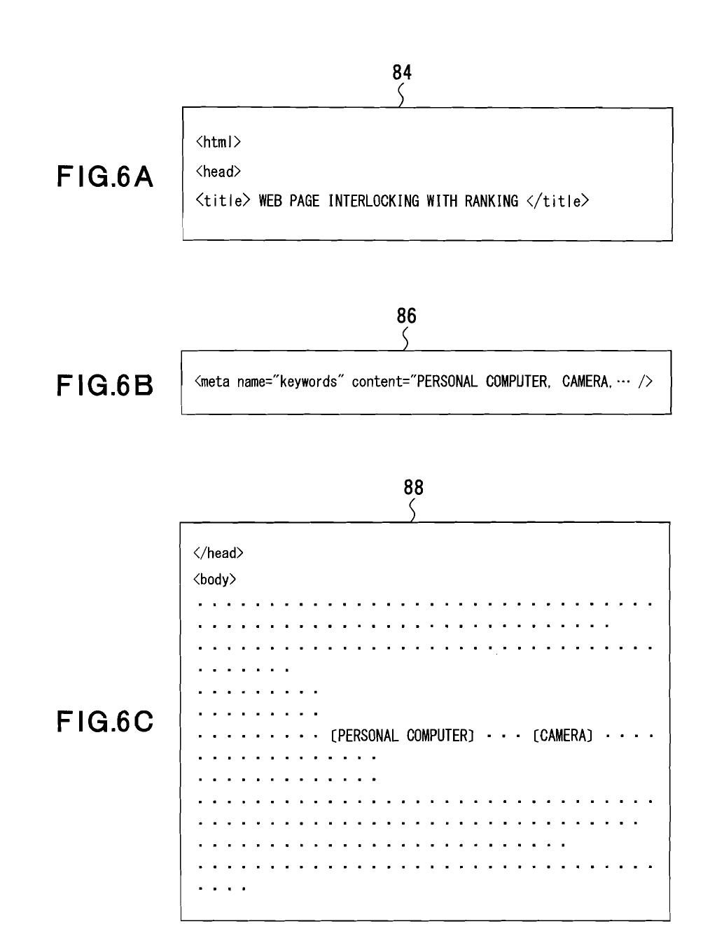

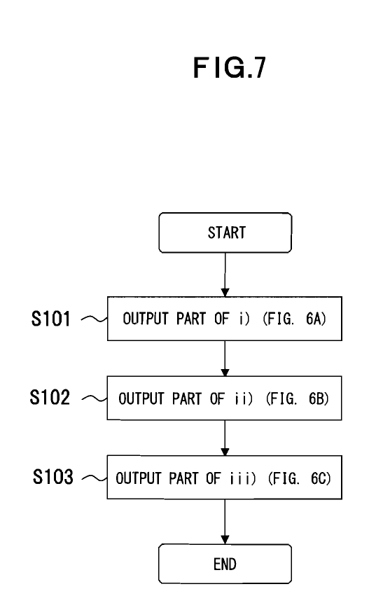

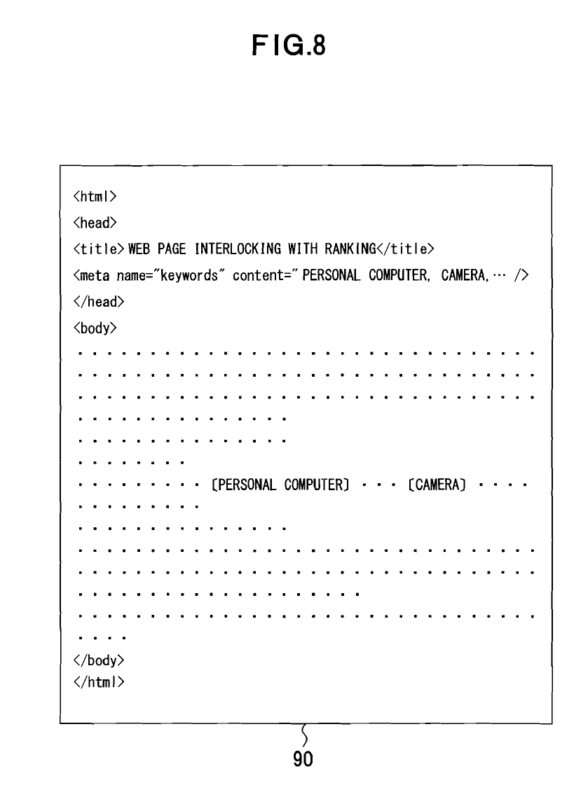

As to a WWW document, FIGS. 6A-6C, 7 and 8 will be referred. FIGS. 6A-6C depict parts of a WWW document, FIG. 7 is a flowchart depicting processing procedure of making a WWW document and FIG. 8 depicts a made WWW document. FIGS. 6A-8 are one example, and such configurations do not limit the present invention.

A WWW document includes, as described above, i) the part above a keyword tag, ii) the part of the keyword tag and iii) the part below the keyword tag, with the part of the keyword tag being the middle. A WWW document is composed of, as depicted in FIG. 6A, a part above a keyword tag 84, as depicted in FIG. 6B, a part of a keyword tag 86 and as depicted in FIG. 6C, a part below a keyword tag 88.

Processing procedure of making a WWW document is as depicted in FIG. 7. The above described i) part above a keyword tag 84 (FIG. 6A) is made to be outputted (step S101), the above described ii) part of a keyword tag 86 (FIG. 6B) is made to be outputted (step S102) and the above described iii) part below a keyword tag 88 (FIG. 6C) is made to be outputted (step S103). By such processing procedure, as depicted in FIG. 8, a WWW document 90 that is one example of an HTML source is made and provided as a WEB page.

In this case, since a place where a file is finally outputted is in a folder published in a server, an HTML source where a part of a keyword is updated is to be outputted if the process of FIG. 7 is ended. For example, if a URL of a Web page desired to be displayed is www.000.com/index.html, a keyword part in index.html is to be updated after the process of FIG. 7 provided that an output file be “index.html” and a place to be outputted be displayed below “www.000.com/”.

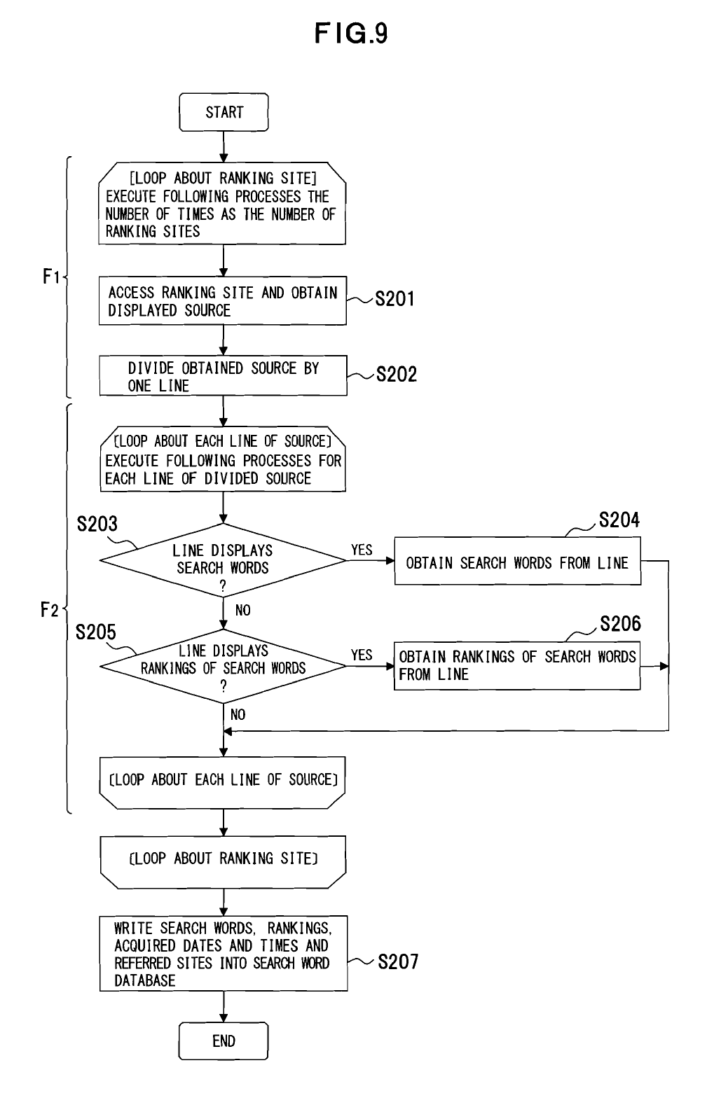

As to collection of search words, FIG. 9 will be referred. FIG. 9 is a flowchart depicting processing procedure of collecting search words. The configuration depicted in FIG. 9 is one example, and such configuration does not limit the present invention.

Collection of search words is executed via a word ranking site, etc. Processing procedure thereof is one example of a method for interlocking a Web page with ranking or a program therefor, and embraces, as depicted in FIG. 9, an accessing process F1 according to the number of ranking sites and a search process F2 for search words in each line of a source in each ranking site. The accessing process F1 represents a loop about ranking sites. In this accessing process F1, processes of steps S201 and 202 are executed the number of times as the number of ranking sites desired to be referred to. The search process F 2 represents a loop for each line of a divided source. In this search process F2, processes of steps S203, 204, 205 and 206 are executed for each line.

In this processing procedure, the accessing process F1 is executed. In this accessing process F1, a ranking site is accessed, and a displayed source (information source) is obtained (step S201). The obtained source is divided by one line (step S202) and the searching process F2 for search words in each line of the source is executed.

In this search process F2, whether a line displays search words is determined (step S203). If search words are displayed (YES of step S203), search words are obtained from the line (step S204).

If search words are not displayed in the line (NO of step S203), it is determined whether the line displays rankings of search words (step S205). If the line displays the rankings of search words (YES of step S205), the rankings of search words are obtained from the line (step S206).

If the line does not display rankings of search words (NO of step S205), the process moves to the process F1 if search is executed for all the lines. When a loop process for all the ranking sites is ended, search words, rankings, acquired dates and times and referred sites obtained from each line of the source are written into the search word database 16 (step S207), and the process is ended.

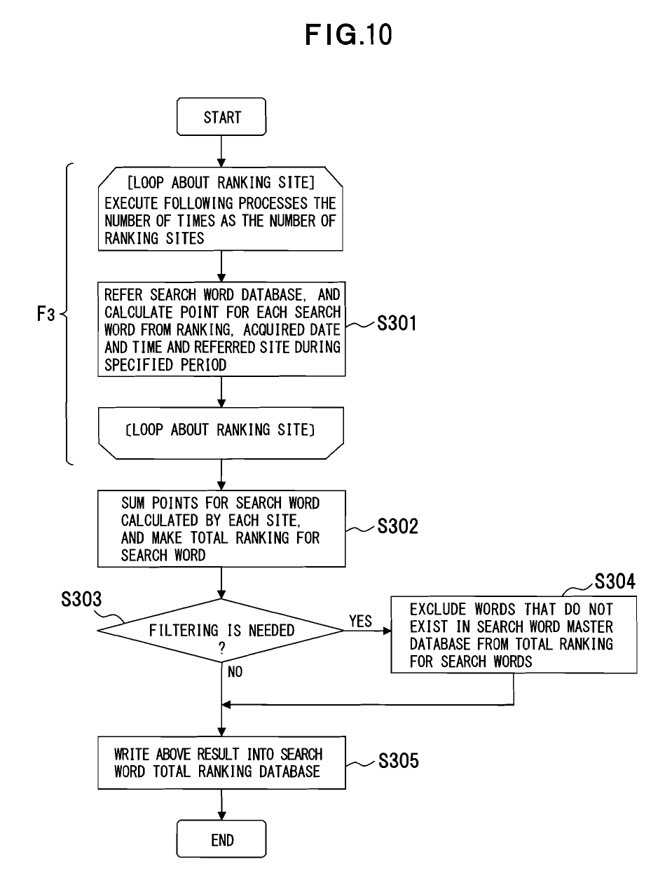

As to analysis of search words, FIG. 10 will refer. FIG. 10 is a flowchart depicting processing procedure of analyzing search words. Configuration depicted in FIG. 10 is one example, and such configuration does not limit the present invention.

This analysis of search words is one example of a method for interlocking a Web page with ranking or a program therefor, is a process in the search word analyzer 14, and as depicted in FIG. 10, includes a process F3 of obtaining ranking information about ranking sites and weighting the same. This process F3 is a loop about ranking sites. In this process F3, a process of step S301 is executed the number of times as the number of ranking sites desired to be referred.

In this processing procedure, concerning each ranking site, the search word database 16 is referred and a point for each search word is calculated from a ranking, acquired date and time and a referred site during a specified period (step S301). Points for the search words calculated by each site are summed, and total ranking for the search words is made (step S302). Whether filtering is needed is determined (step S303). If filtering is needed (YES of step S303), words that do not exist in the search word master database 18 are excluded from the total ranking for search words (step S304).

If filtering is not needed (NO of step S303), the above result is written into the search word total ranking database 26 (step S305). After words that do not exist in the search word master database 18 are excluded at step S304, the process is ended.

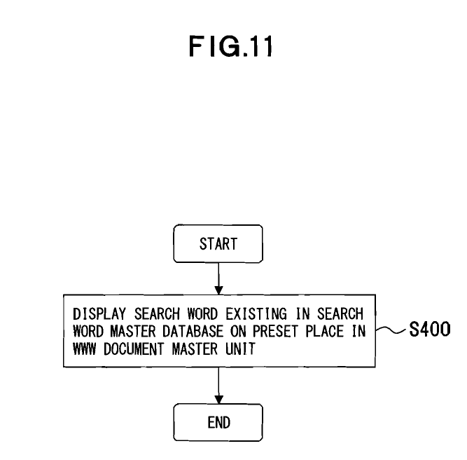

In processing procedure of making a WWW document, as depicted in the flowchart in FIG. 11, search words existing in the search word master database 18 are displayed on a preset place in the WWW document master unit (step S400), and the process is ended.

Features and advantages are listed below concerning the above described first embodiment.

Keywords such as buzzwords collected from the Internet (words of high rankings in a search word ranking site, etc.) can be automatically implanted into a Web page. When a keyword is searched by a browser such as a search engine, the Web page can be displayed at a high ranking of a search result by the highly ranked keyword.

(2) Fashionable keywords can be automatically displayed on a Web page. A ranking of the Web page where the keywords are displayed can be raised.

(3) In response to transition of buzzwords immediately, a Web page can be modified with reflecting buzzwords. Moreover, keywords such as buzzwords on the Internet can be automatically collected, and ranking thereof and addition and modification of keywords of high rankings can be automatically performed. Thus, updating and modification of a Web page can be speedily performed, and operation on manual can be reduced.

(4) Provision of a Web page in advance of fashion can be contributed.

### Second Embodiment

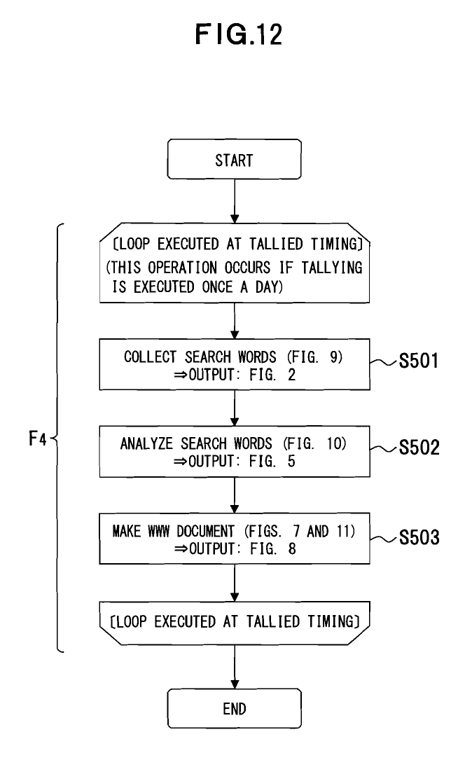

A second embodiment will refer to FIG. 12. FIG. 12 is a flowchart depicting processing procedure of collecting and analyzing search words and making a WWW document according to a second embodiment. A configuration depicted in FIG. 12 is one example, and such configuration does not limit the present invention.

In the first embodiment, processes of collecting and analyzing keywords such as buzzwords and making a WWW document are described irrelevantly to time transition. The second embodiment realizes processes of collecting and analyzing keywords such as buzzwords and making a WWW document by a certain time interval, e.g., a day. In this embodiment, the Web page providing system 10 (FIG. 1) is also used as well as the first embodiment.

Processing procedure of collecting search words and making a WWW document is one example of a method for interlocking a Web page with ranking or a program thereof. As depicted in FIG. 12, the processing procedure includes a process F4, that is, automatic collection of search words, analysis thereof and automatic modification of a WWW document.

In this processing procedure, for example, a process of collecting search words and making a WWW document occurs at timing of once a day and a process of collecting search words (FIG. 9) is executed. As an output thereof, the search word table 32 (FIG. 2) is made (step S501), the search words are analyzed, and as an output thereof, the search word total ranking table 70 (FIG. 5) is made (step S502). After such ranking, a WWW document using the search words is made, and as an output thereof, the WWW document 90 (FIG. 8) is made (step S503).

Therefore, the same effects as the first embodiment can be obtained by such embodiment. Especially, in this embodiment, processes of collection and analysis of keywords such as buzzwords and making a WWW document are executed by a day, and a Web page can be modified by a day. Thus, a search result can be highly ranked.

### Third Embodiment

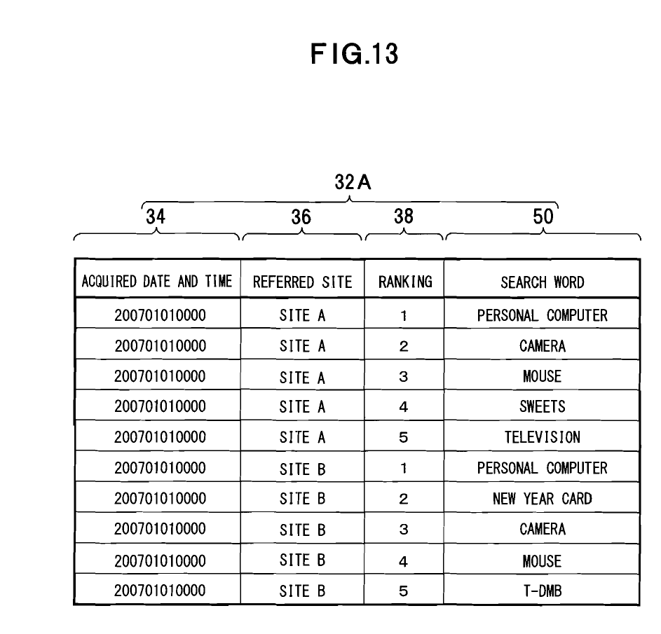

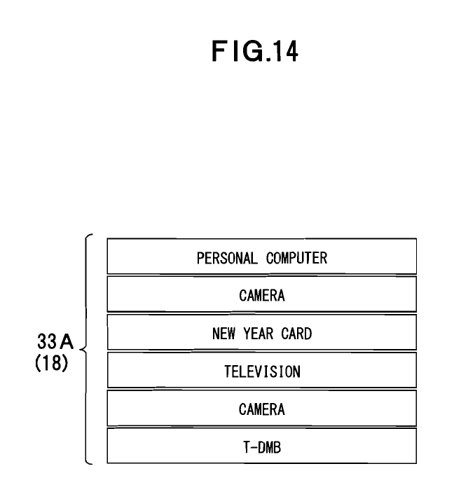

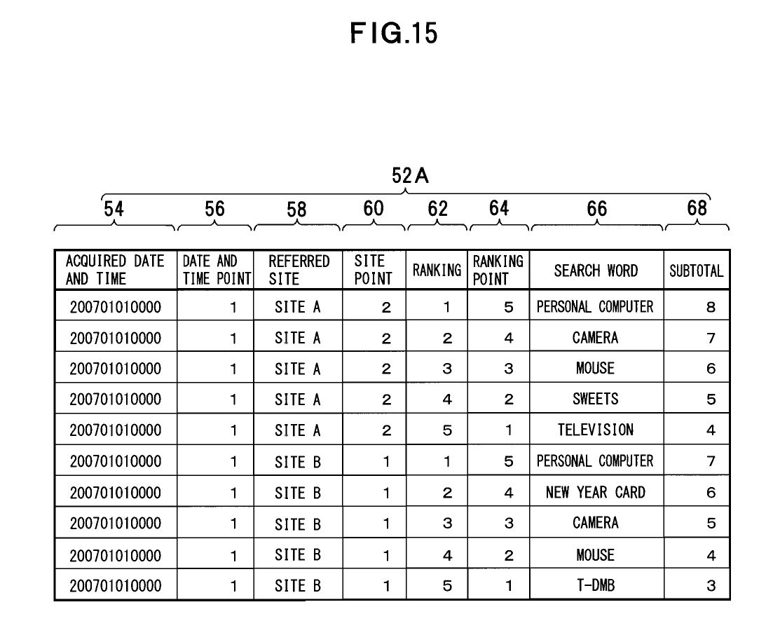

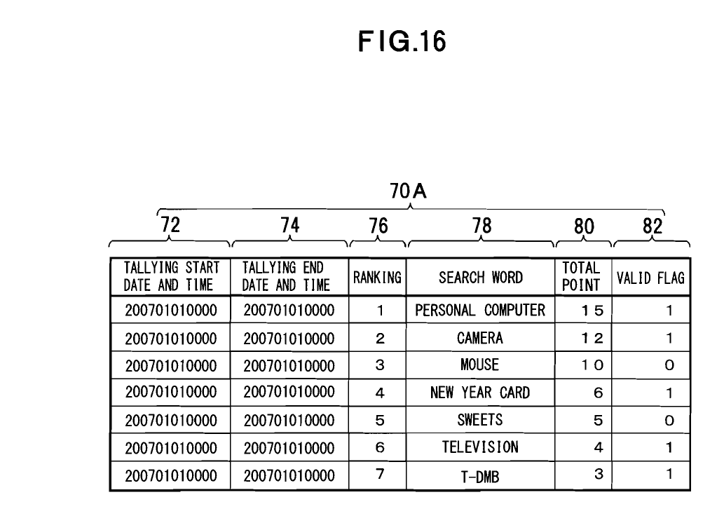

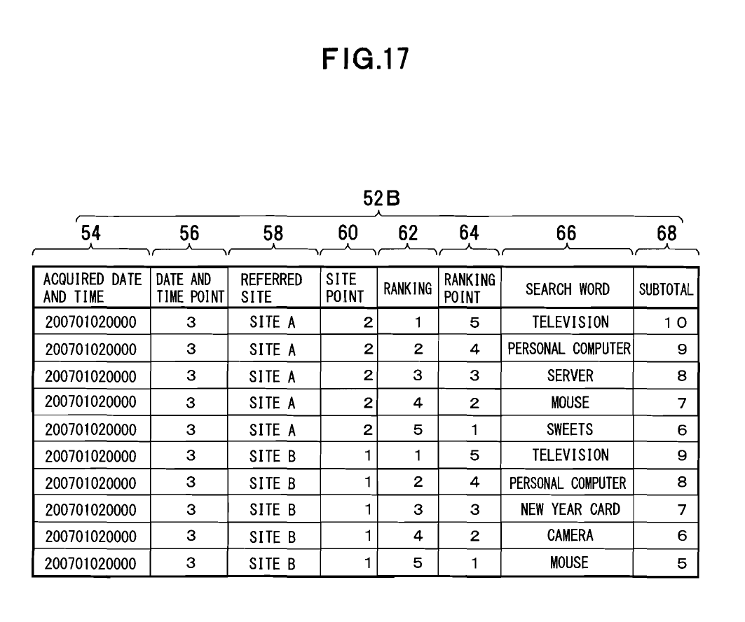

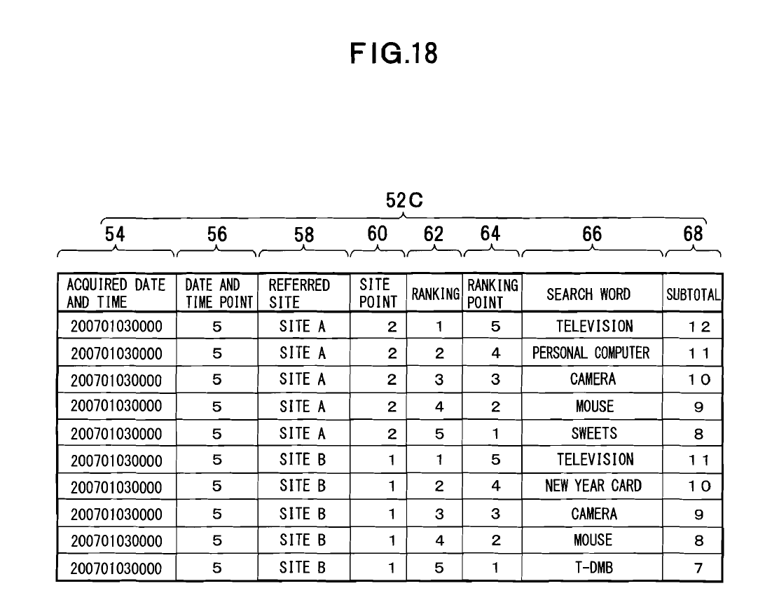

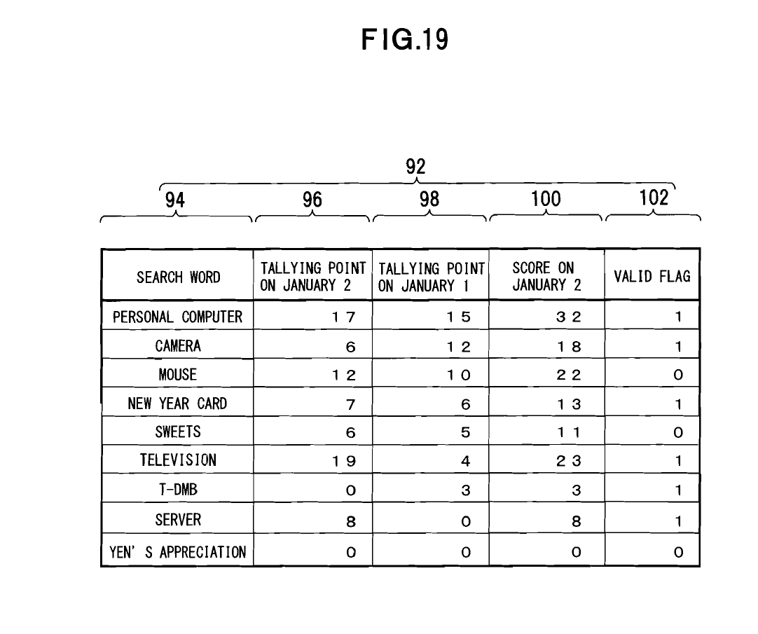

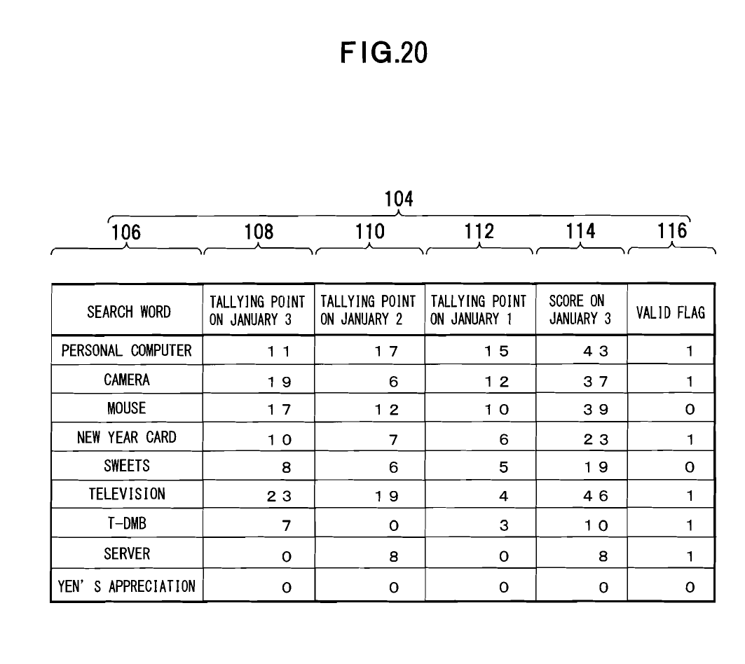

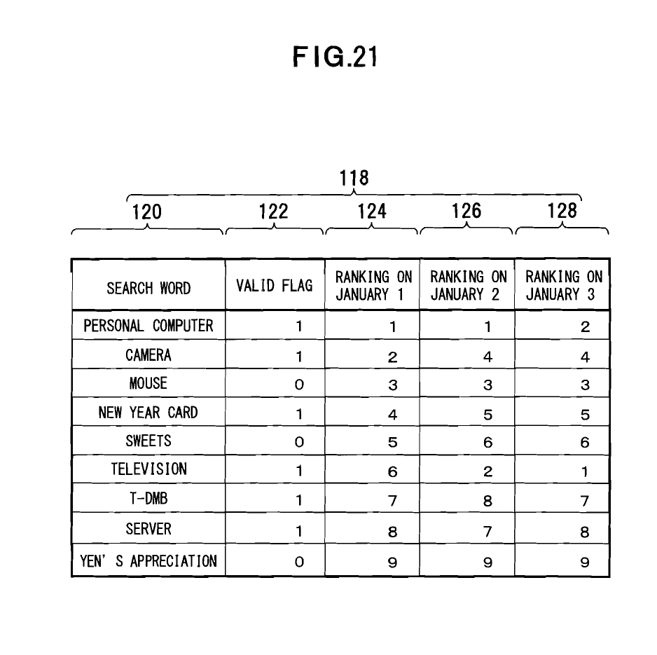

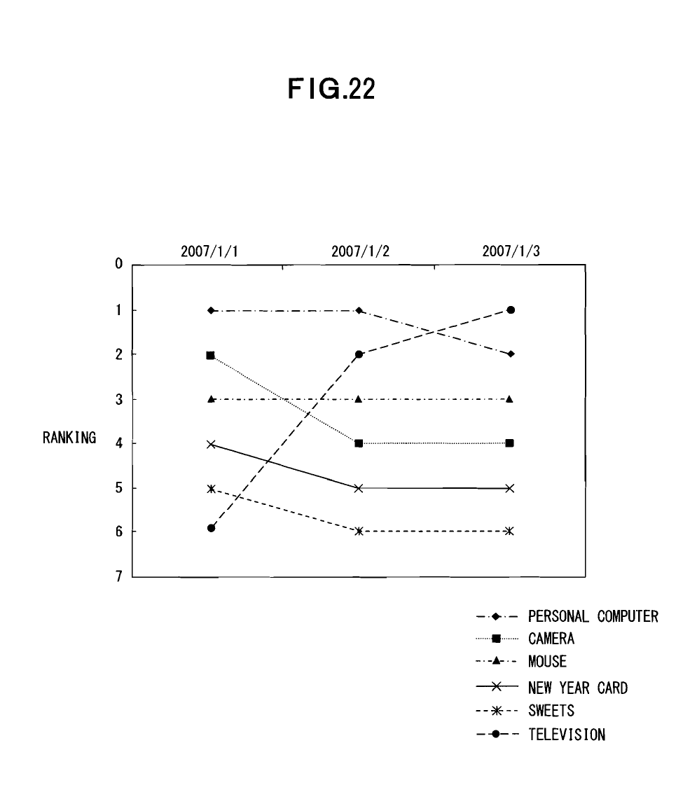

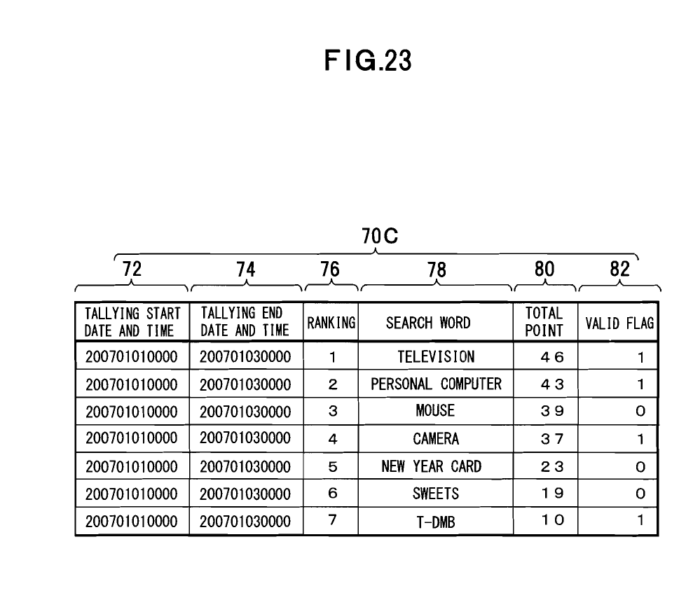

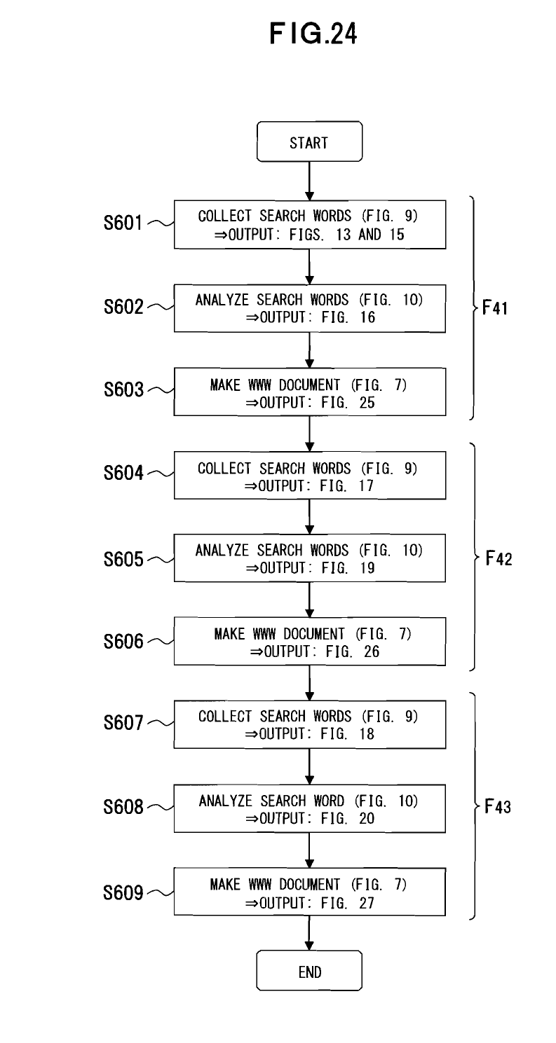

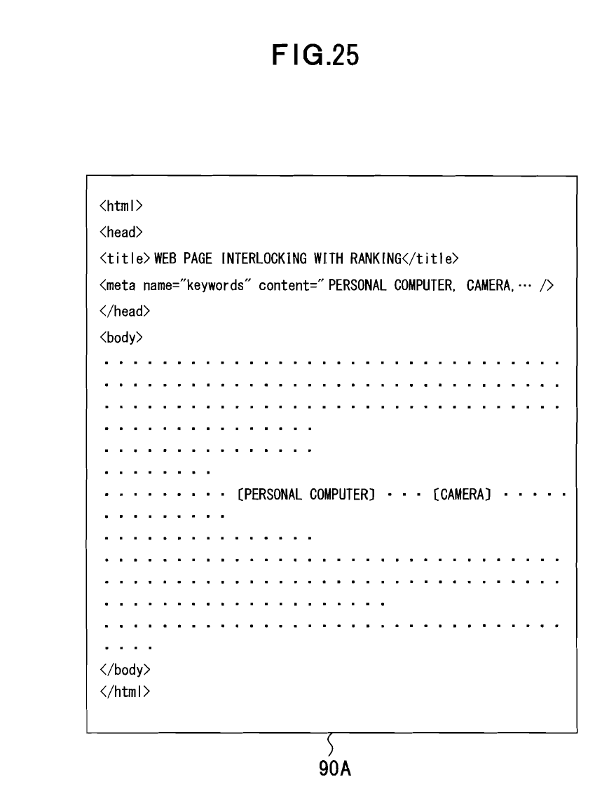

A third embodiment will be described with reference to FIGS. 13, 14, 15, 16, 17, 18, 19, 20, 21, 22, 23, 24, 25, 26 and 27. FIG. 13 depicts a data configuration of a search word database according to the third embodiment, FIG. 14 depicts a data configuration of a search word master database, FIG. 15 depicts a data configuration of a search word database when data is analyzed, FIG. 16 depicts a data configuration of a search word total ranking database, FIGS. 17 and 18 depict a data configuration of a search word database when data is analyzed, FIGS. 19 and 20 depict a score table of search words, FIG. 21 depicts a ranking transition table of search words, FIG. 22 depicts transition of rankings of search words, FIG. 23 depicts a data configuration of a search word total ranking database, FIG. 24 is a flowchart depicting processing procedure of collecting and analyzing search words and making a WWW document and FIGS. 25, 26 and 27 depict automatic modification of a WWW document. Configurations depicted in FIGS. 13, 14, 15, 16, 17, 18, 19, 20, 21, 22, 23, 24, 25, 26 and 27 are one example, and such configurations do not limit the present invention. In FIGS. 13, 14, 15, 16, 17, 18, 19, 23, 25, 26 and 27, the same components as FIGS. 2, 3, 4, 5 and 8 are denoted by the same reference numerals.

This third embodiment embodies the first and the second embodiments. It is exemplified that “search word 1”=“personal computer”, “search word 2”=“camera”, “search word 3”=“mouse”, “search word 4”=“sweets”, “search word 5”=“television”, “search word 6”=“New Year card” and “search word 7”=“T-DMB (terrestrial digital media broadcasting)”, and processes of collecting and analyzing keywords and making a WWW document from Jan. 1, 2007 to Jan. 3, 2007 are realized.

As to these search words, a search word table 32A (FIG. 13) is made on the basis of data acquired date and time: Jan. 1, 2007. In this case, search words “personal computer” . . . “T-DMB” in the search word table 32A correspond to search words 1 to 7 respectively in the search word table 32 (FIG. 2).

In a search word master table 33A (FIG. 14), “personal computer”, “camera”, “New Year card”, “television” and “T-DMB” are set as search words.

By a point giving process for search words when data is analyzed on Jan. 1, 2007, each search word is scored as represented in a search word table 52A (FIG. 15). As a result, search word total ranking at a time point on Jan. 1, 2007 is ranked as represented in a search word total ranking table 70A (FIG. 16).

As to these search words, a search word table 52B (FIG. 17) is made on the basis of data acquired date and time: Jan. 2, 2007. Similarly, a search word table 52C (FIG. 18) is made on the basis of data acquired date and time: Jan. 3, 2007.

In response to transition of these dates and times, a score table 92 (FIG. 19) is made. For this score table 92, a search word field 94, tallying point fields 96 and 98 that correspond to tallied dates and times, a score field 100 and a valid flag field 102 are set. Into the search word field 94, the above described search words “personal computer” . . . are written. In the tallying point field 96, a tallying point at a time point on January 2 is stored, in the tallying point field 98, a tallying point at the time point on January 1 is stored, in the score field 100, a score at the time point on January 2 is stored, and in the valid flag field 102, a valid flag “1” or an exclusion flag “0” is stored.

In response to transition of these dates and times, a score table 104 (FIG. 20) is made. In this score table 104, a search word field 106, tallying point fields 108, 110 and 112 that correspond to tallied dates and times, a score field 114 and a valid flag field 116 are set. Into the search word field 106, the above described search words “personal computer” . . . are written. In the tallying score field 108, a tallying score at a time point on January 3 is stored, in the tallying score field 110, a tallying score at the time point on January 2 is stored, in the tallying score field 112, a tallying score at the time point on January 1 is stored, in the score field 114, a score at the time point on January 3 is stored, and in the valid flag field 116, a valid flag “1” or an exclusion flag “0” is stored.

A ranking transition table 118 (FIG. 21) representing these dates and times and transition of rankings is made. In this ranking transition table 118, a search word field 120, a valid flag field 122 and ranking fields 124, 126 and 128 are set. Into the search word field 120, the above described search words “personal computer” . . . are written. In the valid flag field 122, a valid flag “1” or an exclusion flag “0” is stored, in the ranking field 124, a ranking on January 1 is stored, in the ranking field 126, a ranking on January 2 is stored and in the ranking field 128, a ranking on January 3 is stored. Transition of a ranking of each search word, as depicted in FIG. 22, varies during January 1 and January 3.

It is found that the search word total ranking at the time point on January 3 varies as depicted in a search word total ranking table 70C (FIG. 23).

Such processing procedure of searching and analyzing keywords and making a WWW document in connection with time progress is one example of a method for interlocking a Web page with ranking or a program therefor. As depicted in FIG. 24, a process F41 at the time point on January 1, a process F42 at the time point on January 2 and a process F43 at the time point on January 3 are sequentially executed.

In this processing procedure, as the process F41, the collecting process of search words (FIG. 9) is executed. As an output thereof, the search word tables 32A and 52A (FIGS. 13 and 15) are made (step S601). The analyzing process of collected search words (FIG. 10) is executed. As an output thereof, the search word total ranking table 70A (FIG. 16) is made (step S602). Based on this ranking of search words, the making process of a WWW document (FIG. 7) is executed, and as an output thereof, a WWW document 90A at the time point on January 1 (FIG. 25) is made (step S603).

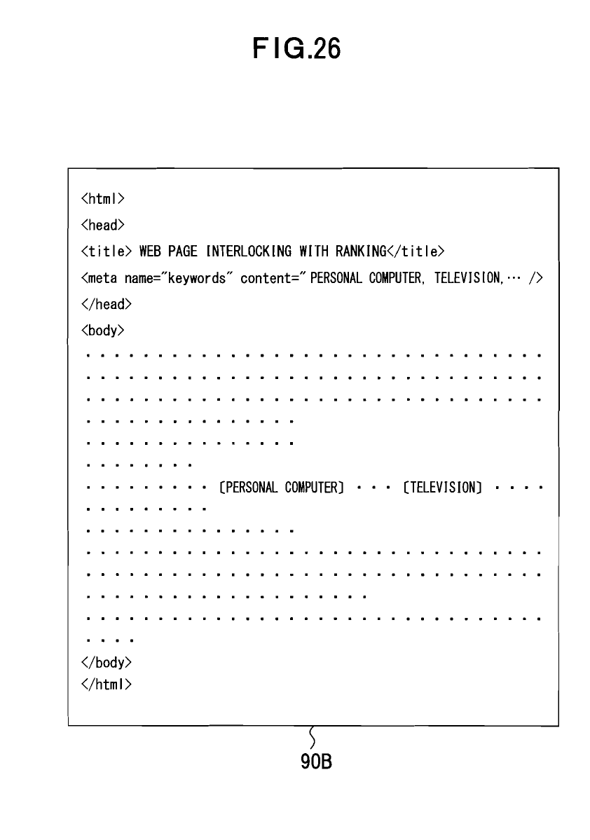

After this process F41, as the process F42, the collecting process of search words (FIG. 9) is executed. As an output thereof, the search word table 52B (FIG. 17) is made (step S604). The analyzing process of collected search words (FIG. 10) is executed. As an output thereof, a search word total ranking table 70B not depicted is made (step S605). Based on this ranking of search words, the making process of a WWW document (FIG. 7) is executed. As an output thereof, a WWW document 90B at the time point on January 2 (FIG. 26) is made (step S606).

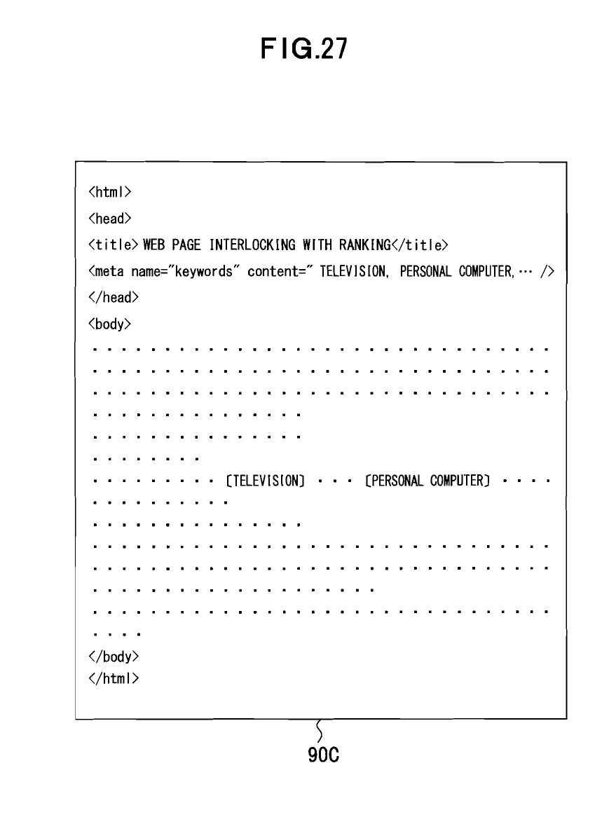

After this process F42, as the process F43, the collecting process of search words (FIG. 9) is executed. As an output thereof, the search word table 52C (FIG. 18) is made (step S607). The analyzing process of collected search words (FIG. 10) is executed. As an output thereof, a search word total ranking table 70C (FIG. 23) is made (step S608). Based on this ranking of search words, the making process of a WWW document (FIG. 7) is executed. As an output thereof, a WWW document 90C at the time point on January 3 (FIG. 27) is made (step S609).

As described in the above, on condition that a point on Jan. 1, 2007 is FIG. 15, a point on Jan. 2, 2007 is FIG. 17 and a point on Jan. 3, 2007 is FIG. 18, a score at the time point on January 2 is FIG. 19 and a score at the time point on January 3 is FIG. 20. Based on these scores, that ranking is made for each search word by a day is FIG. 21, which is represented visually is FIG. 22. Like the above, by weighting date and time points, varying ranking of ranking sites can be followed temporally. For the above reason, as depicted in FIG. 23, the search word total ranking table 70C on January 3 is made. In this example, data within three days is treated as valid. For example, ranking at a time point on January 4 is made based on the rankings on January 2, January 3 and January 4.

In this embodiment, the effects as well as the first and the second embodiments can be obtained, and transition of ranking varying by a day is reflected to the now. Thus, a Web page that always ranks its search result high can be provided.

### Fourth Embodiment

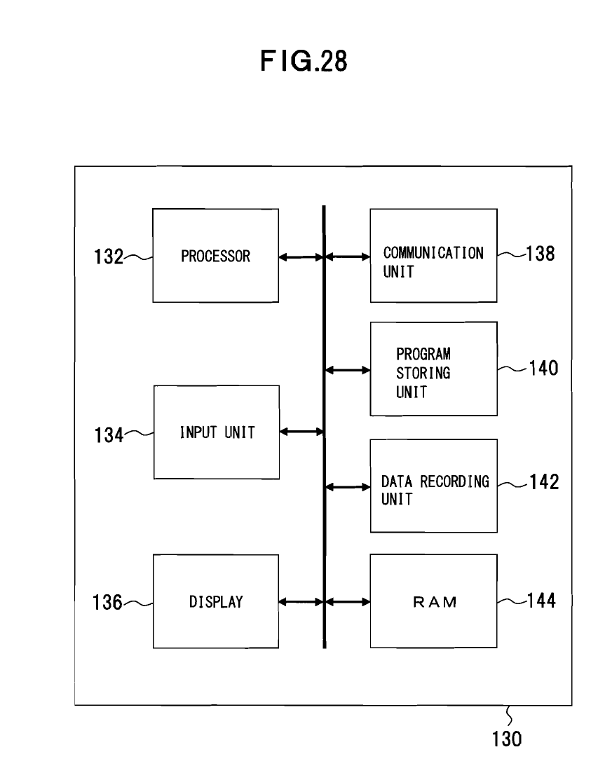

A fourth embodiment will be described with reference to FIG. 28. FIG. 28 depicts a computer. A configuration depicted in FIG. 28 is one example, and such configuration does not limit the present invention.

The server 1 and the server 2 that are Web page providing apparatuses in the first embodiment are configured by a computer 130 (FIG. 28). This computer 130 includes, as depicted in FIG. 28, a processor 132, an input unit 134, a display 136, a communication unit 138, a program storing unit 140, a data recording unit 142 and a RAM (Random-Access Memory) 144.

The processor 132 is a processing part that executes an OS (Operating System) and an application program existing in the program storing unit 140, executes the above described program for interlocking a Web page with ranking and a subroutine thereof, and executes a process such as the above described search word collection, search word analysis and making of WWW document. The processor 132 is disposed in a portal site, etc.

The input unit 134 is an input means (part) for information. The display 136 is an information displaying means (part). The communication unit 138 is a communication means (part) that sends and receives information to and from a Web site, etc. via a network such as an Internet 30.

The program storing unit 140 is a recording means (part) that stores an OS, an application program, the above described program for interlocking a Web page with ranking and a subroutine thereof. The data recording unit 142 is a means (part) that records the above various kinds of information to construct a data table and a database. The RAM 144 is a work area for executing various processes.

Using such computer 130 can construct the above described server 1 and the server 2 (FIG. 1), configure a search word collector 12 and a search word analyzer 14 by the processor 132, configure a search word database 16 and a search word master database 18 by the data recording unit 142, configure a WWW document making unit 22 by the processor 132, configure a WWW document master unit 24 and a search word total ranking database 26 by the data recording unit 142, etc., and construct the above described Web page providing system 2 and the Web page providing apparatus to enable realization of a method for interlocking a Web page with ranking and a program therefor.

### Other Embodiments

In the above embodiments, a plurality of sites are referred. Only ranking of a single Web site may be referred to modify a Web page by keywords reacting to the ranking.

In the first embodiment, the server 1 and the server 2 are used. The configuration of the server 1 and the server 2 may be composed by a single server.

In the first embodiment, it is described that the search word table 52 is stored into the search word database 16. The search word table 52 may be stored into a side of the search word total ranking database 26.

The embodiments of the present invention are related to providing a Web page on the Internet and modification thereof, in which keywords such as buzzwords can be reflected in a Web page automatically, and raise search ranking of a Web page when keyword search is executed by a search program such as a search engine.

According to the embodiments of the present invention, the following effects can be obtained.

Since keywords such as buzzwords can be reflected in a Web page automatically, search ranking of a Web page can be raised when keyword search is executed by a search program such as a search engine.

Since ranking by a site where keywords such as buzzwords that vary on a network is referred, keywords of high searched potentiality can be extracted to be reflected in a Web page.

Since a Web page is automatically modified by automatically collecting keywords such as buzzwords in the Web page, the Web page can always be modified by keywords following fashion to be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A Web page providing apparatus providing a Web page on a network, comprising:
a search word collection part that accesses a Web site on a network and collects a search word from the Web site;
an acquisition part that acquires ranking information of the search word from the Web site;
a search word ranking part that refers to the ranking information and ranks the search word;
a ranking search word accumulation part that stores the search word ranked by the search word ranking part; and
a Web page modification part that describes the search word into a providing Web page according to ranking of the ranked search word to modify the Web page.

2. The Web page providing apparatus of claim 1, comprising a search word accumulation part that accumulates the search word collected by the search word collection part, the search word accumulation part accumulating the search word along with at least date and time information and collected Web site information.

3. The Web page providing apparatus of claim 1, wherein the search word ranking part ranks the search word with using at least one or two of a ranking of the search word on a Web site, acquired date and time of the search word and the searched Web site for a specified period for the ranking information, or by giving a point to the ranking information.

4. A method for making a Web page provided on a network interlock with ranking, comprising:
accessing a Web site on a network and collecting a search word from the Web site;
acquiring ranking information of the search word from the Web site;
referring to the ranking information and ranking the search word;
storing the ranked search word along with the ranking information into a ranking search word accumulation part; and
describing the search word into a providing Web page according to ranking of the ranked search word to modify the Web page.

5. The method for making a Web page interlock with ranking of claim 4, comprising accumulating the search word along with at least date and time information and collected Web site information into a search word accumulation part which accumulates the collected search word.

6. The method for making a Web page interlock with ranking of claim 4, comprising ranking the search word with using at least one or two of a ranking of the search word on a Web site, acquired date and time of the search word and the searched Web site for a specified period for the ranking information, or by giving a point to the ranking information.

7. A computer readable recording medium storing a program for making a Web page provided on a network interlock with ranking, the program allowing a computer to execute:
accessing a Web site on a network and collecting a search word from the Web site;
acquiring ranking information of the search word from the Web site;
referring to the ranking information and ranking the search word;
storing the ranked search word along with the ranking information into a ranking search word accumulation part; and
describing the search word into a providing Web page according to ranking of the ranked search word to modify the Web page.

8. The recording medium of claim 7, the program further allowing a computer to execute accumulating the search word along with at least date and time information and collected Web site information into a search word accumulation part which accumulates the collected search word.

9. The recording medium of claim 7, the program further allowing a computer to execute ranking the search word with using at least one or two of a ranking of the search word on a Web site, acquired date and time of the search word and the searched Web site for a specified period for the ranking information, or by giving a point to the ranking information.
